(19) United States
(12) Patent Application Publication
(10) Pub. No.: US 2018/0365623 A1
(43) Pub. Date: Dec. 20, 2018

(54) MANAGING INTERACTION WITH ORGANIZATION BASED ON WORK PERIOD

(71) Applicant: MICROSOFT TECHNOLOGY LICENSING, LLC, Redmond, WA (US)

(72) Inventor: Anant TRIVEDI, Seattle, WA (US)

(73) Assignee: MICROSOFT TECHNOLOGY LICENSING, LLC, Redmond, WA (US)

(21) Appl. No.: 15/624,722

(22) Filed: Jun. 16, 2017

(51) Int. Cl. G06Q 10/06; G06Q 10/08; G06Q 10/10

(52) U.S. Cl. CPC G06Q 10/063116; G06Q 10/06315; G06Q 10/1091; G06Q 10/087; G06Q 10/06312

(57) ABSTRACT

Variety of approaches to manage an interaction with an organization based on a work period are described. A productivity service initiates operation(s) to manage an interaction with the organization upon determining an initial work period of the organization. Upon receiving a status update associated with an asset of the organization, a determination is made on whether the status update affects the initial work period. In response to a determination that the status update affects the initial work period, the initial work period of the organization is modified based on the status update. The modified work period is provided to a stakeholder entity.

### BACKGROUND

Information exchange have changed processes associated work and personal environments. Automation and improvements in processes have expanded scope of capabilities offered for personal and business data consumption. With the development of faster and smaller electronics, execution of mass processes at cloud systems have become feasible. Indeed, applications provided by data centers, data warehouses, data workstations have become common features in modern personal and work environments. Productivity service(s) provide a wide variety of applications ranging from management, tracking, and/or support of asset(s) associated with organization(s).

Increasingly, cloud based resources are utilized for variety of services that include productivity services, among others that facilitate management, tracking, and/or support, among other operations associated with assets such as employee(s) and inventory. However, there are currently substantial gaps in managing interaction(s) with an organization based on a work period. Personnel resources are unnecessarily consumed for processing, maintaining, and/or updating schedule(s) associated with organization(s). Lack of relevant management solutions to dynamically manage an interaction with an organization based on a work period cause poor management of personnel resources and time when attempting to manage, track, and update a status of an organization based on status updates associated with assets.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to management of an interaction with an organization based on a work period. A productivity service, according to embodiments, may initiate operations to manage an interaction with the organization upon determining an initial work period of the organization. Upon receiving a status update associated with an asset of the organization, a determination may be made on whether the status update affects the initial work period. In response to a determination that the status update affects the initial work period, the initial work period of the organization may be modified based on the status update. The modified work period may be provided to a stakeholder entity.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of managing an interaction with an organization based on a work period, according to embodiments;

FIG. 2 is a display diagram illustrating example components of a productivity service that manages an interaction with an organization based on a work period, according to embodiments;

FIG. 3 is a display diagram illustrating components of a scheme to manage an interaction with an organization based on a work period, according to embodiments;

FIG. 4 is a display diagram illustrating an additional example of a scheme to manage an interaction with an organization based on a work period, according to embodiments;

FIG. 5 is a simplified networked environment, where a system according to embodiments may be implemented;

FIG. 6 is a block diagram of an example computing device, which may be used to manage an interaction with an organization based on a work period; and

FIG. 7 is a logic flow diagram illustrating a process for managing an interaction with an organization based on a work period, according to embodiments.

### DETAILED DESCRIPTION

As briefly described above, a productivity service may manage an interaction with an organization based on a work period. In an example scenario, the productivity service may determine an initial work period of the organization. The organization may include a business, an educational entity, and/or a governmental entity, among others. The initial work period may include work hours during a time period such as a work day, work week, and/or among others. Upon receiving a status update associated with an asset of the organization, a determination may be made on whether the status update affects the initial work period. The asset may include an employee, and/or an inventory, among others. The status update may describe an availability and or an unavailability of the, asset within a portion and or an entirety of the initial work period.

In response to a determination that the status update affects the initial work period, the initial work period of the organization may be modified based on the status update. The asset may be identified as critical to an operation of the organization. If the status update reflects an unavailability of the asset within the initial work period, the initial work period may be modified to coincide with an availability of the asset. If the asset is detected as unavailable during an entirety of the initial work period, the modified work period may reflect a closed status of the organization during the modified work period. Next, the modified work period may be provided to a stakeholder entity. The stakeholder entity, such as a customer, an employee, and/or a related organization, among others, may be informed and/or warned about the modified work period.

In the following detailed description, references are made to the accompanying drawings that form a part hereof and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for managing an interaction with an organization based on a work period. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience a visual display associated with an application or service trough which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

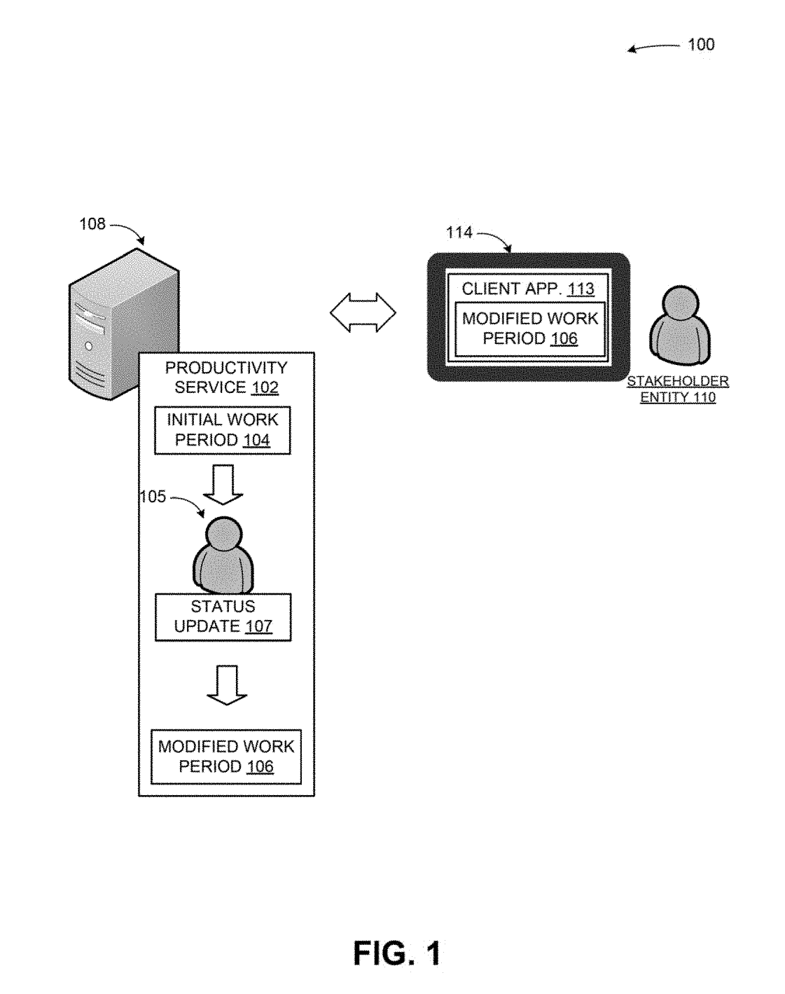

FIG. 1 is a conceptual diagram illustrating examples of managing an interaction with an organization based on a work period, according to embodiments.

In a diagram 100, a server 108 may execute (or provide) a productivity service 102. The server 108 may include a physical server providing service(s), application(s), and/or an interface to client devices. A service (such as the productivity service 102) may include an application performing operations in relation to a client application and/or a subscriber, among others. The server 108 may include and/or is part of a workstation, a data warehouse, a data center, and/or a cloud based distributed computing source, among others.

The server 108 may execute the productivity service 102. The productivity service 102 may provide functionality to manage, track, and/or support asset(s) and/other component(s) of an organization. The productivity service 102 may determine an initial work period 104 of the organization. The organization may include a business, an educational entity and/or a governmental entity, among others. The initial work period 104 may include work hours during a time period such as a work day, work week, and/or among others. Upon receiving a status update 107 associated with an asset 105 of the organization, a determination may be made on whether the status update 107 affects the initial work period 104. The asset 105 may include an employee, and/or an inventory, among others. The status update 107 may describe an availability and/or an unavailability of the asset 105 within a portion and/or an entirety of the initial work period 104. The status update 107 may be received from the asset 105, such as an employee. Alternatively, the status update 107 may be gathered from an information provider such as a web site associated with the organization, a social networking presence of the organization, and/or a data provider associated with the organization. The productivity service 102 may determine whether the status update 107 affects the initial work period 104.

In response to a determination that the status update 107 affects the initial work period 104, the initial work period 104 of the organization may be modified based on the status update 107. The asset 105 may be identified as critical to an operation of the organization. If the status update 107 reflects an unavailability of the asset 105 within the initial work period 104, the initial work period 104 may be modified to coincide with an availability of the asset 105. If the asset 105 is detected as unavailable during an entirety of the initial work period 104, the modified work period 106 may reflect a closed status of the organization during the modified work period 106. Next, the modified work period 106 may be provided to a stakeholder entity 110. The stakeholder entity 110, such as a customer, an employee, and/or a related organization, among others, may be informed of the modified work period 106 by transmitting the modified work period 106 to a client application 113. The client application 113 (executed by a client device 114) may be prompted to provide the modified work period 106 to the stakeholder entity 110.

The server 108 may communicate with the client device 114, through a network. The network may provide wired or wireless communications between network nodes such as the client device 114 and/or the server 108, among others. Previous example(s) to manage an interaction with an organization based on a work period are not provided in a limiting sense. Alternatively, the productivity service 102 may modify the initial work period 104 based on the status update 107 (that impacts the asset 105 of the organization) and provide the modified work period 106 to the stakeholder entity as a desktop application, a workstation application, and/or a server application, among others. The client application 113 may also include a client interface interacting with the productivity service 102.

The stakeholder entity 110 may interact with the client application 113 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the server 108, the productivity service 102, embodiments are not limited to these components or system configurations and can be implemented with other system configuration employing fewer or additional components.

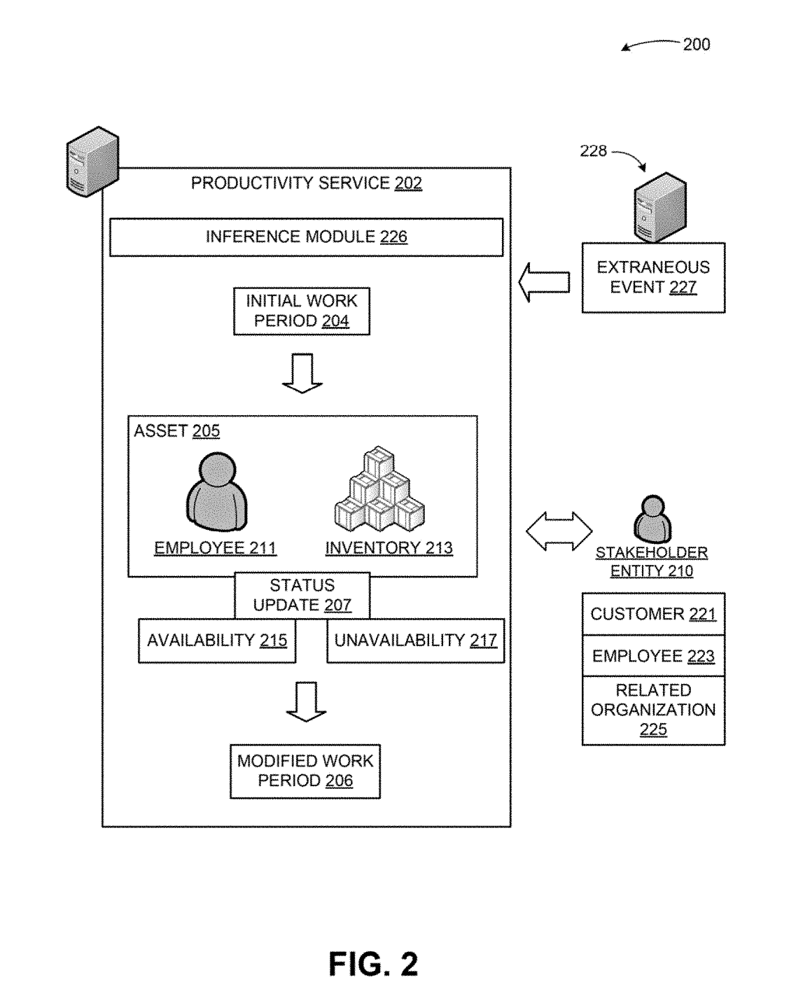

FIG. 2 is a display diagram illustrating example components of a productivity service that manages an interaction with an organization based on a work period, according to embodiments.

As illustrated in diagram 200, an inference module 226 of a productivity service 202 may determine an initial work period 204 of an organization The organization may include a business, an educational entity, and/or a governmental entity, among others. The initial work period 204 of the organization may be retrieved from an information provider associated with the organization. For example, the information provider may include a web site associated with the organization, a social networking presence of the organization, and/or a data provider associated with the organization, among others.

The initial work period 204 may include work hours during a time period such as a work day, work week, and/or among others. The work hours are when the organization is available to provide service(s) to a stakeholder entity 210 such as a customer 221, an employee 223, a patron, and/or a related organization 225, among others. The initial work period 204 may also be determined based on input by an authoritative entity associated with the organization (such as an individual with a management role in the organization).

The initial work period 204 is subject to modification based on a status update 207 associated with an asset 205. The asset 205 may be determined as critical to an operation of the organization. As such, an unavailability of the asset 205 may cause the organization to close and/or operate at diminished capacity which may alter the initial work period 204. An example of the asset 205 may include an employee 211 and/or an inventory 213.

In an example scenario, a status update 207 associated with the asset 205 may be received (and/or detected). The status update 207 may affect the initial work period 204 adversely because the status update may include an unavailability of the asset 205. For example, the employee 211 may transmit a communication that identifies the employee 211 as unavailable (due to illness, vacation, and/or time off, among other reasons). Similarly, the inventory 213 may be detected (based on information provided by an inventory management service) as at a level that falls below an operational threshold. The operational threshold may define a level of the inventory 213 at or above which the organization may stay operational.

The status update 207 may include an unavailability 217 of the asset 205. The unavailability 217 may span an entirety of the initial work period 204. In such a scenario, the initial, work period 204 may be modified to reflect a closed status of the organization. For example, the initial work period 204 may state that the organization is open between 8:00 AM to 5:00 PM on a specific weekday. However, the modified work period 206 may state that the organization is closed between 8:00 AM to 5:00 PM on the specific weekday. The closed status reflected by the modified work period 206 may continue during the unavailability 217 of the asset 205. Upon start of a new work period (in which the asset 205 is determined as available), the new work period may be determined to reflect an open status of the organization.

Alternatively, the unavailability 217 may span a portion of the initial work period 204. In such a scenario, the initial work period 204 may be modified to reflect an availability 215 of the asset 205. The modified work period 206 may coincide with a remaining portion of the initial work period 204 in which the availability 215 of the asset 205 is detected. For example, the initial work period 204 may state that the organization is open between 8:00 AM to 5:00 PM on a specific weekday. A status update 207 may be received that describes the unavailability 217 of the asset 205 between 1:00 pm to 5:00 PM on the specific weekday. The initial work period 204 may be updated to the modified work period 206 that reflects an open status of the organization between 8:00 AM to 1:00 PM (alternatively 12:59:59 PM) and a closed status of the organization between 1:00 PM to 5:00 PM.

In an example scenario, a level of the inventory 213 may be detected to fall below the operational threshold during the initial work period. Alternatively, the level of the inventory 213 may be inferred to fall below the operational threshold at a specific time in the initial work period based on consumption tracking and management operations. Next, the asset 205 may be designated as unavailable through the status update 207. The initial work period 204 may also be updated to the modified work period 206 that reflects the unavailability 217 of the inventory 213.

Furthermore, a restocking event associated with the inventory 213 may be detected. The restocking event may be a planned event and/or a spontaneous event that reflects a replenishment of the inventory 213. Next, the level of the inventory 213 may be confirmed to exceed or equal the operational threshold. Upon a confirmation, the asset 205 may be designated as available. The modified work period 206 may also be updated to reflect an open status of the organization based on the availability 215 of the asset 205.

In an additional example scenario, an extraneous event 227 may be detected. The extraneous event 227 may include a natural event, a utility resource based event, a holiday event, and/or a vacation based event, among others. The extraneous event 227 may be received from an external provider 228 such as an information service. The information associated with the extraneous event 227 may be detected as impacting the initial work period 204. As such, the initial work period 204 may be modified based on the extraneous event 227.

For example, if a natural event is detected that prevents the employee 211 and/or a delivery of the inventory 213 then the status update 207 may be generated (and/or received from an information source) that reflects the unavailability 217 of the asset 205. Similarly, if a utility resource based event is detected as disrupting service to the organization then the status update 207 may be generated (and/or received from an information source) that reflects the unavailability 217 of the asset 205. Furthermore, a holiday based event and/or a vacation based event may be detected (and/or received from an information source) that produces the status update 207 reflecting the unavailability 217 of the asset 205. Upon detecting the unavailability 217 of the asset 205, the initial work period 204 may be modified to coincide with a duration of the unavailability 217 of the asset 205.

The modified work period 206 may be provided to the stakeholder entity 210. In another example scenario, a scheduled event such as a task, an appointment, and/or a meeting, among others associated with the initial work period 204 may be detected. If the modified work period 206 is detected as adversely impacting the scheduled event (such as causing a cancellation of the scheduled event) then the stakeholder entity 210 (associated with the scheduled event) may be contacted with a request to confirm the modified work period 206.

If a confirmation is received then the scheduled event may be rescheduled based on the modified work period 206. If the modified work period describes the organization as open during a portion of the initial work period 204 then the scheduled event may be attempted to be rescheduled to a time period within the modified work period 206. If the modified work period 206 describes the organization as closed during an entirety of it e initial work period 204, then the scheduled event may be attempted to be rescheduled to other time period of the organization (such as a time period after the initial work period 204). Alternatively, if the confirmation of the modified work period 206 is not received from the stakeholder entity 210 then a cancellation of the scheduled event may be transmitted to the stakeholder entity 210.

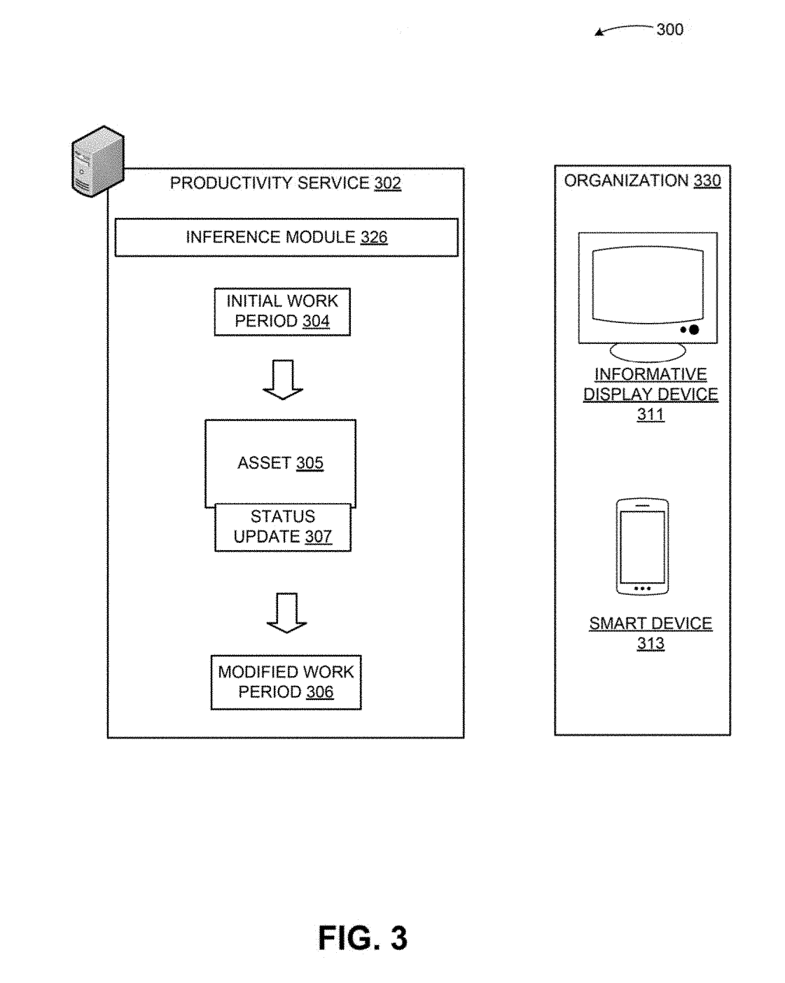

FIG. 3 is a display diagram illustrating components of a scheme to manage an interaction with an organization based on a work period, according to embodiments.

As shown in a diagram 300, an inference module 326 of a productivity service 302 may receive a status update 307 that reflects an unavailability of an asset 305 that is critical to an operation of an organization 330. In response to the status update 307, the inference module 326 may modify an initial work period 304 of the organization 330 based on the status update 307. A modified work period 306 may reflect a closed status of the organization 330 during an entirety of the initial work period 304 or an open status during a portion of the initial work period 304 based on a duration of the unavailability of the asset 305.

The inference module 326 may provide the modified work period 306 to an informative display device 311 associated with the organization 330. An example of the informative display device 311 may include an open and/or closed sign (such as lighting) that displays an open and/or closed notification associated with the organization 330. Furthermore, the informative display device 311 may display the work period of the organization 330. The modified work period 306 may be provided to prompt the informative display device 311 to display a notification reflecting the open status of the organization 330 during an availability of the asset 305 (that spans a portion of the initial work period 304). In addition, the informative display device 311 may display the modified work period 306. Alternatively, the informative display device 311 may be prompted to display a closed status of the organization through the modified work period 306 during an entirety of the initial work period 304 (based on a duration of the unavailability of the asset 305 that spans the initial work period 304). In such a scenario, the modified work period 306 may reflect a closed status of the organization 330 during an entirety of the initial work period 304.

The inference module 326 may also provide the modified work period 306 to a smart device 313 associated with the organization 330. An example of the smart device 313 may include an alarm system, an ambient temperature controller, and/or a lighting controller, among others. The smart device 313 may be prompted to execute operation(s) associated with the organization 330 based on the modified work period 306. For example, an alarm system may be prompted to activate an away mode (that may activate an alarm upon detecting an intrusion into the organization 330) upon receiving the modified work period 306 which may reflect a dosed status of the organization. Similarly, the ambient temperature controller may be prompted to activate a conservation mode in response to the modified work period 306 which may reflect a dosed status of the organization. A lighting controller may also be prompted to turn-off and/or dim the lights (associated with the organization 330) to coincide with the closed status of the organization 330 reflected by the modified work period 306.

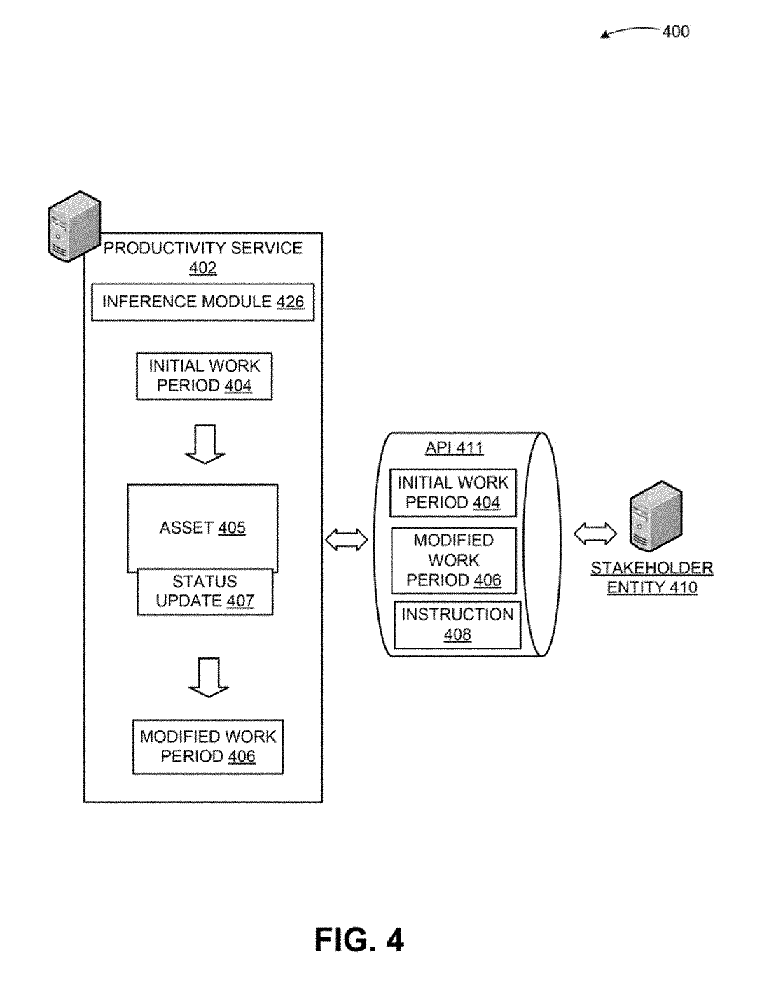

FIG. 4 is a display diagram illustrating an additional example of a scheme to manage an interaction with an organization based on a work period, according to embodiments.

As shown in a diagram 400, an inference module 426 of a productivity service 402 may communicate with a stakeholder entity 410 through an application programming interface (API) 411. The API may be configured to communicate an initial work period 404 of the organization and a modified work period 406 of the organization to the stakeholder entity 410 in response to a status update 407. The status update 407 may reflect a status of an asset 405 that is critical to an operation of the organization. For example, if the status update 407 reflects an unavailability of the asset 405 (during a portion of the initial work period 404) then the modified work period 406 may be designated to include diminished work hours compared to the initial work period 404. Alternatively, the modified work period 406 may also reflect a closed status of the organization during an entirety of the initial work period 404 (if the status update 407 is determined as reflecting an unavailability of the asset 405 during the entirety of the initial work period 406).

An instruction 408 may also be transmitted through the API 411 to prompt the stakeholder entity 410 to publish the initial work period 404 and/or the modified work period 406. The stakeholder entity 410, such as a social networking service, a notification service, and/or a website service, among others may be instructed through the API to publish the initial work period 404 and/or the modified work period 406 to inform and/or warn entity(s) affected by the modified work period 406.

As discussed above, the productivity service may be employed to perform operations to manage an interaction with an organization based on a work period. An increased performance and efficiency improvement with the productivity service 102 may occur as a result of detecting a status update of an asset that is critical to an operation of an organization. Additionally, modification of an initial work period based on the status update and providing the modified work period to a stakeholder entity based operation(s) and process(es) executed by the productivity service 102, may reduce processor load, increase processing speed, conserve memory, and reduce network bandwidth usage.

Embodiments, as described herein, address a need that arises from a lack of efficiency to manage an interaction with an organization based on a work period. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Managing an interaction with an organization based on a work period may be implemented in configurations employing fewer or additional components in applications and user interfaces. Furthermore, the example schema and components shown in FIG. 1 through 4 and their subcomponents may be implemented in a similar manner with other values using the principles described herein.

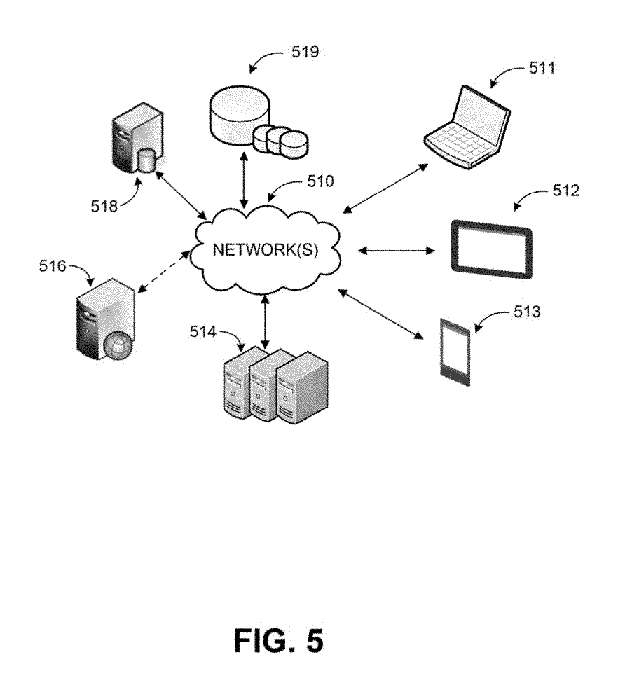

FIG. 5 is an example networked environment, where embodiments may be implemented. A productivity service configured to manage an interaction with an organization based on a work period may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A productivity service may determine an initial work period of the organization. Upon receiving a status update associated with an asset of the organization, a determination may be made on whether the status update affects the initial work period. In response to a determination that the status update affects the initial work period, the initial work period of the organization may be modified based on the status update. The modified work period may be provided to a stakeholder entity. The productivity service may store data associated with a work period in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication networks such as Public Switched Telephone Network (PSTN) or cellular networks. Furthermore, network(s) 510 may include short range wireless networks such as Bluetooth Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to manage an interaction with an organization based on a work period. Furthermore, the networked environments discussed in FIG. 5 are for illustration purposes only. Embodiments are not limited to the example applications, modules, or processes.

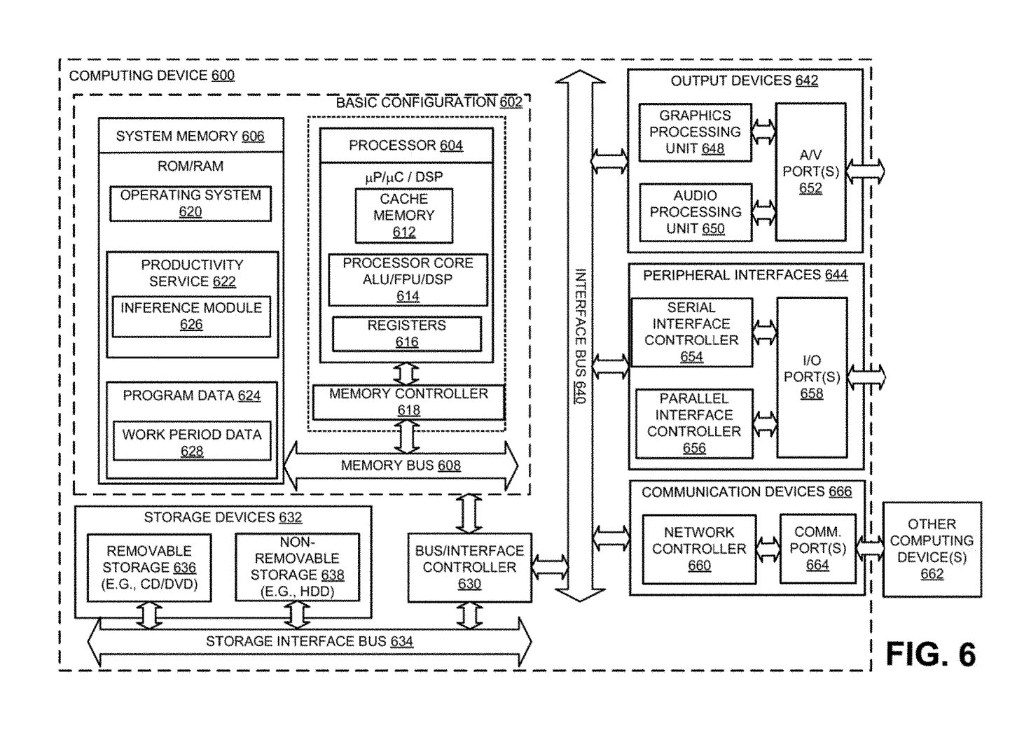

FIG. 6 is a block diagram of an example computing device, which may be used to manage, an interaction with an organization based on a work period, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), a graphics processing unit (GPU), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a productivity service 622, and a program data 624. The productivity service 622 may include components such as an inference module 626. The inference module 626 may execute the processes associated with the productivity service 622. The inference module 626 may determine an initial work period of the organization. Upon receiving a status update associated with an asset of the organization, a determination may be made on whether the status update affects the initial work period. In response to a determination that the status update affects the initial work period, the initial work period of the organization may be modified based on the status update. The modified work period may be provided to a stakeholder entity.

Input to and output out of the productivity service 622 may be transmitted through a communication device 666 that may be communicatively coupled to the computing device 600. The communication device 666 may provide wired and/or wireless communication. The program data 624 may also include, among other data, work period data 628, or the like, as described herein. The work period data 628 may include information associated with an initial work period, a modified work period, and/or an asset, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interlaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a specialized server, mainframe, or similar computer, which includes any of the above functions. The computing device 600 may also be implemented as a personal computer including both laptop computer and non-laptop computer configurations. Additionally, the computing device 600 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to manage an interaction with an organization based on a work period. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

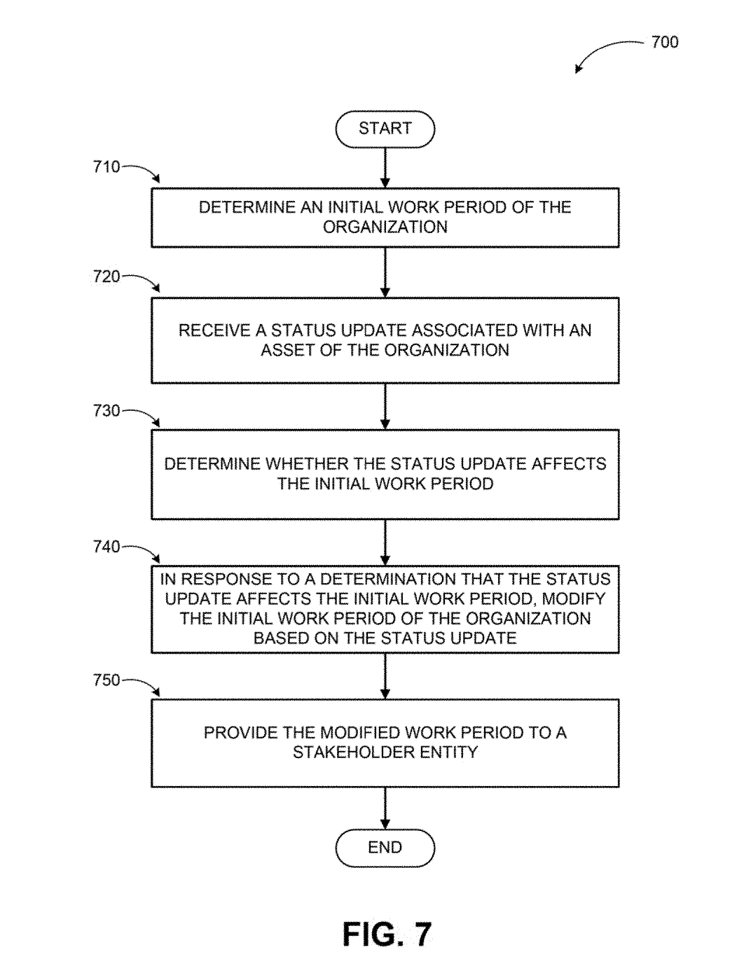

FIG. 7 is a logic flow diagram illustrating a process for managing an interaction with an organization based on a work period, according to embodiments. Process 700 may be implemented on a computing device, such as the computing device 600 or another system.

Process 700 begins with operation 710, where a productivity service may determine an initial work period of the organization. The initial work period may include work hours during a time period such as a work day, work week, and/or among others. At operation 720, a status update associated with an asset of the organization may be received. The status update may reflect an unavailability of the asset within the initial work period. At operation 730, a determination may be made on whether the status update affects the initial work period. The asset may be critical to an operation of the organization. As such, an unavailability of the asset may adversely affect the initial work period.

At operation 740, in response to a determination that the status update affects the initial work period, the initial work period of the organization may be modified based on the status update. At operation 750, the modified work period may be provided to a stakeholder entity. The stakeholder entity, such as a customer, an employee, and/or a related organization, among others, may be informed and/or warned about the modified work period.

The operations included in process 700 is for illustration purposes. Managing an interaction with an organization based on a work period may be implemented by similar processes with fewer or additional steps, as well as in different order of operations using the principles described herein. The operations described herein may be executed by one or more processors operated on one or more computing devices, one or more processor cores, specialized processing devices, and/or special purpose processors, among other examples.

According to some examples, a method to manage an interaction with an organization based on a work period is described. The method includes determining an initial work period of the organization, receiving a status update associated with an asset of the organization, determining whether the status update affects the initial work period, in response to a determination that the status update affects the initial work period, modifying the initial work period of the organization based on the status update, and providing the modified work period to a stakeholder entity.

According to other examples, determining the work period of the organization includes retrieving the initial work period of the organization from an information provider associated with the organization, where the information provider includes one or more of a web site associated with the organization, a social networking presence of the organization, and a data provider associated with the organization. The method further includes providing a notification associated with the modified work period to one or more of a web site associated with the organization, a social networking presence of the organization, and a data provider associated with the organization.

According to further examples, the method further includes determining the asset as critical to an operation of the organization and determining the status update to include an unavailability of the asset during at least a portion of the initial work period. The method further includes determining the unavailability of the asset to encompass a first portion of the initial work period and modifying the initial work period to coincide with a remaining portion of the initial work period. The method further includes determining the unavailability of the asset to encompass an entirety of the initial work period and modifying the initial work period to reflect a closed status of the organization during the unavailability of the asset.

According to other examples, the method further includes detecting an appointment associated with the stakeholder entity during the initial work period, identifying the modified work period as adversely impacting the appointment, and requesting the stakeholder entity to confirm the modified work period. The method further includes upon receiving a confirmation of the modified work period from the stakeholder entity, rescheduling the appointment based on the modified work period. The method further includes upon a failure to receive a confirmation of the modified work period from the stakeholder entity, transmitting a cancellation of the appointment to the stakeholder entity. The method further includes prompting an informative display device to render the modified work period. The stakeholder entity includes one or more of a customer, an employee, and a related organization.

According to some examples, a server configured to manage an interaction with an organization based on a work period is described. The server includes a communication device configured to facilitate communication between a productivity service and one or more client devices, a memory configured to store instructions, and a processor coupled to the memory and the communication device. The processor executes the productivity service in conjunction with the instructions stored in the memory. The productivity service includes an inference module. The inference module is configured to detect an initial work period of the organization, identify an asset of the organization that is critical to an operation of the organization, detect an unavailability of the asset within the initial work period, modify the initial work period of the organization based on the unavailability of the asset, and provide, through the communication device, the modified work period to a stakeholder entity.

According to other examples, the inference module is further configured to detect an inventory as the asset of the organization, detect a level of the inventory fall below an operational threshold, and designate the asset of the organization as unavailable. The inference module is further configured to detect a restocking event associated with the inventory, confirm the level of the inventory exceed or equal the operational threshold, designate the asset of the organization as available, and update the modified work period of the organization based on the availability of the asset. The inference module is further configured to receive information associated with an extraneous event having an impact on the initial work period and modify the initial work period based on the extraneous event. The extraneous event includes one or more of a natural event, a utility resource based event, a holiday based event, and a vacation based event.

According to further examples, the inference module is further configured to communicate, through the communication device, with the stakeholder entity through an application programming interface (API) to prompt the stakeholder entity to publish the modified work period. The inference module is further configured to provide, through the communication device, the modified work period to a smart device associated with the organization, where the smart device includes an alarm system, an ambient temperature controller, and a lighting controller and prompt, through the communication device, the smart device to execute one or more operations associated with the organization based on the modified work period,

According to some examples, a computer-readable memory device with instructions stored thereon to manage an interaction with an organization based on a work period. The instructions include actions that are similar to the actions provided by the inference module of the productivity service provided by the server.

According to either examples, the instructions further include detecting a critical employee as the asset of the organization, receiving, a status update that designates the critical employee as unavailable within the initial work period, locating an alternative employee who is capable of replacing the critical employee, determining an availability of the alternative employee within the initial work period, and updating the modified work period based on the availability of the alternative employee.

According to some examples a means for managing an interaction with an organization based on a work period is described. The means for managing an interaction with an organization based on a work period includes a means for determining an initial work period of the organization, receiving a status update associated with an asset of the organization, a means for determining whether the status update affects the initial work period, a means for in response to a determination that the status update affects the initial work period, modifying the initial work period of the organization based on the status update, and a means for providing the modified work period to a stakeholder entity.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to manage an interaction with an organization based on a work period, the method comprising:
determining an initial work period of the organization;
receiving a status update associated with an asset of the organization;
determining whether the status update affects the initial work period;
in response to a determination that the status update affects the initial work period, modifying the initial work period of the organization based on the status update; and
providing the modified work period to a stakeholder entity.

2. The method of claim 1, wherein determining the work period of the organization comprises:
retrieving the initial work period of the organization from an information provider associated with the organization, wherein the information provider includes one or more of a web site associated with the organization, a social networking presence of the organization, and a data provider associated with the organization.

3. The method of claim 1, further comprising:
providing a notification associated with the modified work period to one, or more of a web site associated with the organization, a social networking presence of the organization, and a data provider associated with the organization.

4. The method of claim 1, further comprising:
determining the asset as critical to an operation of the organization; and
determining the status update to include an unavailability of the asset during at least portion of the initial work period.

5. The method of claim 4, further comprising:
determining, the unavailability of the asset to encompass a first portion of the initial work period; and
modifying the initial work period to coincide with a remaining portion of the initial work period.

6. The method of claim 4, further comprising:
determining the unavailability of the asset to encompass an entirety of the initial work period; and
modifying the initial work period to reflect a closed status of the organization during the unavailability of the asset.

7. The method of claim 1, further comprising:
detecting an appointment associated with the stakeholder entity during the initial work period;
identifying the modified work period as adversely impacting the appointment; and
requesting the stakeholder entity to confirm the modified work period.

8. The method of claim 7, further comprising:
upon receiving a confirmation of the modified work period from the stakeholder entity, rescheduling the appointment based on the modified work period.

9. The method of claim 7, further comprising:
upon a failure to receive a confirmation of the modified work period from the stakeholder entity, transmitting a cancellation of the appointment to the stakeholder entity.

10. The method of claim 1, further comprising:
prompting an informative display device to render the modified work period.

11. The method of claim 1, wherein the stakeholder entity includes one or more of a customer, an employee, and a related organization.

12. A server configured to manage an interaction with an organization based on a work period, the server comprising:
a communication device configured to facilitate communication between a productivity service and one or more client devices;
a memory configured to store instructions; and
a processor coupled to the memory and the communication device, the processor executing the productivity service in conjunction with the instructions stored in the memory, wherein the productivity service includes:
an inference module configured to:
detect an initial work period of the organization;
identify an asset of the organization Mat is critical to an operation of the organization;
detect an unavailability of the asset within the initial work period;
modify the initial work period of the organization based on the unavailability of the asset; and
provide, through the communication device, the modified work period to a stakeholder entity.

13. The server of claim 12, wherein the inference module is further configured to:
detect an inventory as the asset of the organization;
detect a level of the inventory fall below an operational threshold; and
designate the asset of the organization as unavailable.

14. The server of claim 13, wherein the inference module is further configured to:
detect a restocking event associated with the inventory;
confirm the level of the inventory exceed or equal the operational threshold;
designate the asset of the organization as available; and
update the modified work period of the organization based on the availability of the asset.

15. The server of claim 12, wherein the inference module is further configured to:
receive information associated with an extraneous event having an impact on the initial work period; and
modify the initial work period based on the extraneous event.

16. The server of claim 15, wherein the extraneous event includes one or more of a natural event, a utility resource based event, a holiday based event, and a vacation based event.

17. The server of claim 12, wherein the inference module is further configured to:
communicate, through the communication device, with the stakeholder entity through an application programming interface (API) to prompt the stakeholder entity to publish the modified work period.

18. The server of claim 12, wherein the inference module is further configured to:
provide, through the communication device, the modified work period to a smart device associated with the organization, wherein the smart device includes an alarm system, an ambient temperature controller, and a lighting controller; and
prompt, through the communication device, the smart device to execute one or more operations associated with the organization based on the modified work period.

19. A computer-readable memory device with instructions stored thereon to manage an interaction with an organization based on a work period, the instructions comprising:
detecting an initial work period of the organization;
identifying an asset of the organization that is critical to an operation of the organization;
detecting an unavailability of the asset within the initial work period;
modifying the initial work period of the organization based on the unavailability of the asset; and
providing the modified work period to a stakeholder entity.

20. The computer-readable memory device of claim 19, wherein the instructions further comprise:
detecting a critical employee as the asset of the organization;
receiving a status update that designates the critical employee as unavailable within the initial work period;
locating an alternative employee who is capable of replacing the critical employee;
determining an availability of the alternative employee within the initial work period; and
updating the modified work period based on the availability of the alternative employee.
